(19) United States
(12) Patent Application Publication
(10) Pub. No.: US 2017/0154375 A1
(43) Pub. Date: Jun. 1, 2017

(54) APPARATUS, SYSTEM, AND METHOD FOR RETAIL ADD-ON SALES

(71) Applicant: JDBW HOLDING, LLC, Austin, TX (US)

(72) Inventors: John Domeracki, Austin, TX (US); Brian Woodruff, San Angelo, TX (US)

(73) Assignee: JDBW HOLDING, LLC, Austin, TX (US)

(21) Appl. No.: 14/615,244

(22) Filed: Feb. 5, 2015

Related U.S. Application Data
(60) Provisional application No. 62/026,437, filed on Jul. 18, 2014.

(51) Int. Cl. G06Q 30/06; G06K 7/14; G06Q 20/20; G06K 19/06

(52) U.S. Cl. CPC G06Q 30/0631; G06K 19/06037; G06K 7/1417; G06Q 30/0633; G06Q 20/20

(57) ABSTRACT

Embodiments of apparatuses, systems and methods for retail add-on sales are presented. In one embodiment, a method includes receiving an input at an input interface, the input comprising indicia of a retail item selection. The method may also include searching a database of add-on items available for retail purchase, the database being organized according to a hub and spoke scheme, for one or more add-on items associated with the retail item selection. Additionally, the method may include generating an output associated with the one or more add-on items associated with the retail item selection in response to the search.

### CROSS-REFERENCE TO RELATED APPLICATIONS

This application claims priority to U.S. Provisional Application No. 62/026,437 entitled “RETAIL ADD-ON SALES,” filed Jul. 18, 2014, the entire contents of which is specifically incorporated by reference herein.

### BACKGROUND OF THE INVENTION

Field of the Invention

This invention relates to systems for retail sales and advertising and more particularly relates to an apparatus system and method for retail add-on sales.

Description of the Related Art

The goal of all retailers, on some level, is to increase their total sales. Often measured as UPTs or Units Per Transaction, retailers strive to find new and innovative ways to assist customers with their shopping experience and to add items to the final purchase. Any additional item added to the purchase, no matter the price or margin, represents additional dollars in the retailer's pocket. Online stores have the “customers who viewed this also viewed” option that may lead a customer to view other, more expensive items that helps generate more sales. Online stores also have the “guests who bought this item also bought” option that reflects products that one may want or need that also leads to more sales.

Customers often forget to write something down on their grocery list and arrive home after shopping only to find they need to go back to the store because they forgot something they needed. There are ways of creating mobile grocery lists that users can take to the store but they simply act as just that, a grocery list, nothing more.

### SUMMARY OF THE INVENTION

Embodiments of apparatuses, systems and methods for retail add-on sales are presented. In one embodiment, a method includes receiving an input at an input interface, the input comprising indicia of a retail item selection. The method may also include searching a database of add-on items available for retail purchase, the database being organized according to a hub and spoke scheme, for one or more add-on items associated with the retail item selection. Additionally, the method may include generating an output associated with the one or more add-on items associated with the retail item selection in response to the search.

In one embodiment, the method includes defining a set of core items to be included in the hub and spoke scheme. The method may also include defining a set of accessory items to be associated with each core item in the set of core items. Additionally, the method may include defining associations between each core item in the set of core items and a corresponding set of accessory items.

In an embodiment the output is an advertisement for the one or more items associated with the retail item selection. In another embodiment, the output is a suggestion for adding the one or more items associated with the retail item selection to an order for purchase at a point-of-sale (POS) device. Alternatively, the output is a suggestion for adding the one or more items associated with the retail item selection to an on-line order.

Embodiments of a system may include an input at an input interface configured to receive an input comprising indicia of a retail item selection. The system may also include a processing device in communication with the input interface, the processing device configured to search a database of add-on items available for retail purchase, the database being organized according to a hub and spoke scheme, for one or more add-on items associated with the retail item selection. Additionally, the system may include an output interface in communication with the processing device, the output interface configured to generate an output associated with the one or more add-on items associated with the retail item selection in response to the search.

In one embodiment, the system includes a user interface device in communication with the input interface and the output interface, the user interface device configured to capture the input and to display the output. The user interface device may be a mobile data device. Alternatively, the user interface device is a point-of-sale device. In another embodiment, the user interface device is an inventory control device.

In one embodiment, the input is a Stock Keeping Unit (SKU) number associated with the retail item selection. In some embodiments, the input is derived from a Quick Response (QR) code comprising the indicia of the retail item selection.

A tangible machine-readable medium comprising machine-executable instructions that, when executed by a machine, cause the machine to perform operations is also presented. In an embodiment, the operations include receiving an input at an input interface, the input comprising indicia of a retail item selection. The operations may also include searching a database of add-on items available for retail purchase, the database being organized according to a hub and spoke scheme, for one or more add-on items associated with the retail item selection. Additionally, the operations may include generating an output associated with the one or more add-on items associated with the retail item selection in response to the search.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a schematic block diagram illustrating one embodiment of a system for retail add-on sales.

FIG. 2 is a schematic block diagram illustrating one embodiment of system for retail add-on sales.

FIG. 3 is a schematic block diagram illustrating one embodiment of a system for retail add-on sales.

FIG. 4 is a schematic block diagram illustrating one embodiment of a system for retail add-on sales.

FIG. 5 is a schematic block diagram illustrating one embodiment of a database system for retail add-on sales.

FIG. 6 is a schematic logical diagram illustrating one embodiment of abstraction layers of operation in a system for retail add-on sales.

FIG. 7 is a schematic block diagram illustrating one embodiment of an information handling system configured for retail add-on sales.

FIG. 8 is a schematic block diagram illustrating one embodiment of an apparatus for retail add-on sales.

FIG. 9 is a schematic block diagram illustrating one embodiment of an apparatus for retail add-on sales.

FIG. 10A is a logical diagram illustrating one embodiment of a method for retail add-on sales.

FIG. 10B is a logical diagram illustrating one embodiment of a method for retail add-on sales.

FIG. 11 is a schematic diagram illustrating one embodiment of a method for retail add-on sales.

FIG. 12 is a schematic diagram illustrating one embodiment of a method for retail add-on sales.

FIG. 13A is a conceptual diagram illustrating one embodiment of a method for retail add-on sales.

FIG. 13B is a conceptual diagram illustrating one embodiment of a method for retail add-on sales.

FIG. 13C is a conceptual diagram illustrating one embodiment of a method for retail add-on sales.

FIG. 14 is a conceptual diagram illustrating one embodiment of a method for retail add-on sales.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

In the following description, numerous specific details are provided, such as examples of software components, user selections, network transactions, database queries, database structures, hardware components, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

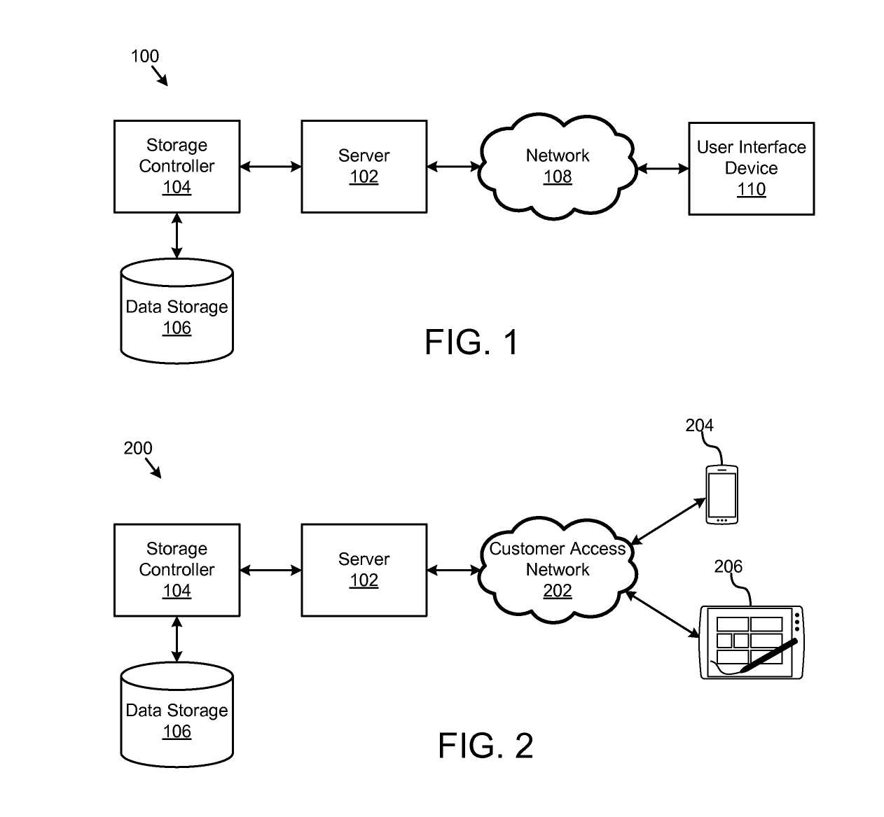

FIG. 1 illustrates one embodiment of a system 100 for retail add-on sales. The system 100 may include a server 102, a data storage device 106, a network 108, and a user interface device 110. In a further embodiment, the system 100 may include a storage controller 104, or storage server configured to manage data communications between the data storage device 106, and the server 102 or other components in communication with the network 108. In an alternative embodiment, the storage controller 104 may be coupled to the network 108. In a general embodiment, the system 100 may provide one or more advertisements, suggestions, or other outputs for retail add-ons associated with a retail item selected by a consumer.

In various embodiments, the user interface device 110 is referred to broadly and is intended to encompass a suitable processor-based device such as a desktop computer, a laptop computer, a smartphone, a tablet device, a Personal Digital Assistant (PDA), other mobile communication devices, retail inventory control devices, point-of-sale interfaces, payment interface devices, etc. having access to the network 108. In a further embodiment, the user interface device 110 may access the Internet to access a web application or web service hosted by the server 102 and provide a user interface for enabling a user to enter or receive information. For example, the user may enter item selections on a mobile purchase application or web-based retail interface hosted by a mobile date device, such as a smartphone or tablet computer.

The network 108 may facilitate communications of data between the server 102 and the user interface device 110. The network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In one embodiment, the server 102 is configured to receive an input comprising indicia of a retail item selection, search a database of add-on items available for retail purchase, the database being organized according to a hub and spoke scheme, for one or more add-on items associated with the retail item selection, and generate an output associated with the one or more add-on items associated with the retail item selection in response to the search. Additionally, the server 102 may access data stored in the data storage device 106 via a Storage Area Network (SAN) connection, a LAN, a data bus, or the like.

The data storage device 106 may include a hard disk, including hard disks arranged in an Redundant Array of Independent Disks (RAID) array, an optical storage device, or the like. In one embodiment, the data storage device 106 may store a database of retail items available for purchase through a retail outlet. The database may be arranged according to a hub and spoke architecture, where certain retail items are defined as core items, and certain other retail items are defined as accessory items. In still a further embodiment, the database may include links to advertisement files, or other advertising data which may be presented to a user through the user interface device for advertising one or more accessory items in response to selection of a core retail item. The data may be arranged in a database and accessible through Structured Query Language (SQL) queries, or other data base query languages or operations.

FIG. 2 illustrates another embodiment of a system 200 for retail add-on sales. In the embodiment of FIG. 2, the system 200 includes a customer access network 202. For example, a customer may enter a brick and mortar retail establishment and connect to the customer access network 202 using, e.g., a smartphone device 204 or a tablet computing device 206. The customer may then use the smartphone device 204 or the tablet computing device 206 to capture or enter inputs including indicia of retail item selections. For example, the customer may use a camera on the smartphone device 202 to capture an image of a Universal Product Code (UPC) barcode, a QR code, or the like. The UPC barcode or QR code may include a SKU number associated with a selected retail item.

By way of example, the customer may select a Halloween costume and scan the UPC barcode on the package of the selected costume package. The smartphone device 204 may communicate the SKU number associated with the captured UPC barcode to the server 102. The server 102 may search for the SKU in the database of retail items which have been defined as accessories to the Halloween costume. The database stored, for example in data storage 106, may return results for one or more accessories associated with the selected SKU. In a further embodiment, the server 102 may compare the list of accessory items in the returned search results with the a list of items selected by the customer and generate suggestions for accessory items that correspond to the selected Halloween costume, which have not already been selected by the customer. In another embodiment, the server 102 may communicate an advertisement for one of the missing accessory items to the smartphone 204, for example.

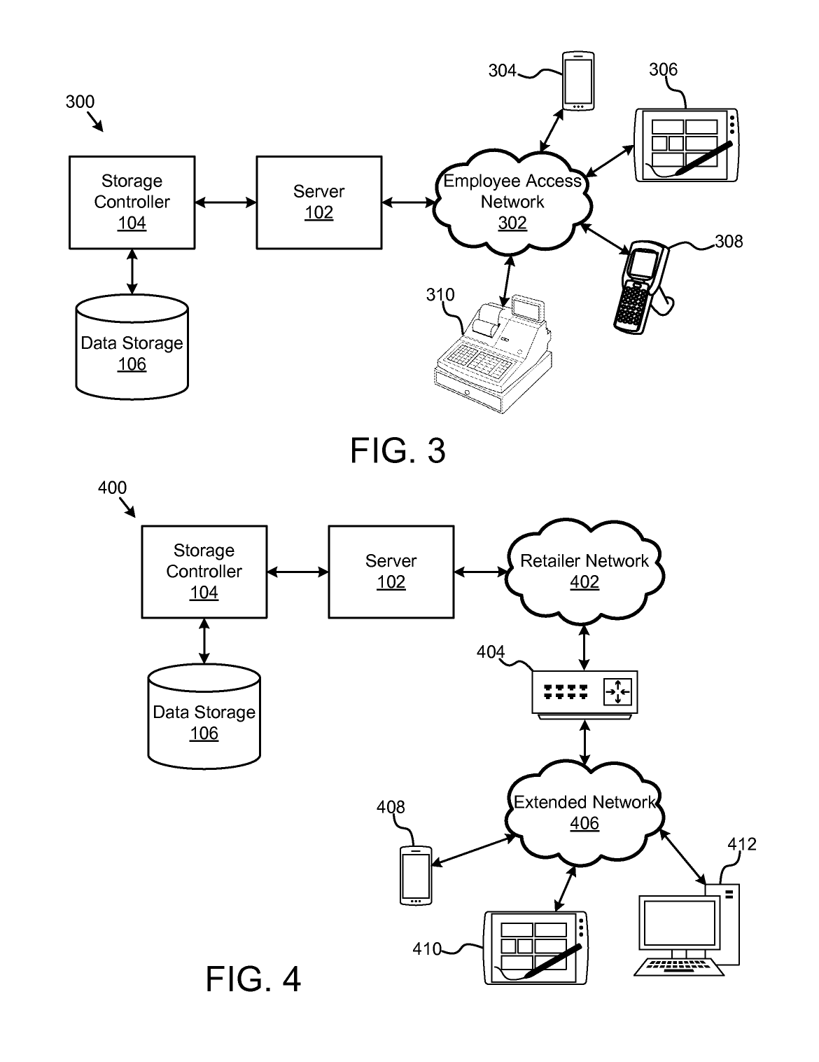

FIG. 3 illustrates another example of a system 300 for retail add-on sales. In the embodiment of FIG. 3, the system 300 includes an employee access network 302. Access to the employee access network 302 may be restricted to authorized devices or authorized employees of the retail establishment. An employee may use an employee interface device, such as smartphone 304, tablet 306, inventory control device 308, or POS device 310 to access the employee access network 302.

In an embodiment, an employee assisting a customer with a retail purchase may enter indicia of one or more items selected by the customer. For example, in a clothing retail establishment, an employee may enter a SKU or other identifier associated with a selected article, such as a pair of jeans. For example, the employee may scan a UPC barcode associated with the selected pair of jeans with an inventory control device 306 or a smartphone device 304, or the like. The SKU may be communicated over the employee access network 302 to server 102. The server 102 may search the database for accessory items, such as shirts, belts, jewelry items, etc. which may coordinate with the selected pair of jeans. The employee may then receive suggested accessories via the inventory control device 308, smartphone, or the like. The employee may then communicate the suggestions to the customer to help the customer coordinate a complete outfit or set of coordinated purchases.

In another example, the customer may take a selected pair of jeans, a selected shirt, etc. to a POS station 310 for checkout. During the checkout process, the POS device 310 may communicate the selections to the server 102, which may search the database and provide advertisements via a customer interface at the POS 310 for coordinating items which have not be selected. For example, the server 102 may identify an article of jewelry which compliments the selected jeans and shirt, but which the customer has not previously selected. The server 102 may then communicate an advertisement for the identified article of jewelry to the POS device 310 for display to the customer.

FIG. 4 illustrates another embodiment of a system 400 for retail add-on sales. In an embodiment, the system includes a retailer network 402 coupled to a network router for interfacing with an extended network 406. For example, the extended network 406 may be the Internet generally, a Wide Area Network (WAN) connection to a retail store, a mobile data network, or the like. In an embodiment, the customer may sue a smartphone 408, a tablet computing device 410, a desktop computing device 412, or any other communication device suitable for communicating with extended network 406.

In an embodiment, the customer may select one or more retail items on an online retail outlet. The selections may be added to an online purchase order, such as an online “shopping cart” or basket. Various implementations of online retail outlets are known by those of ordinary skill in the art of e-commerce or online retail. The selections may be communicated via router 404 to the retailer network 402, and received by the server 102. In an embodiment, the server 102 may search the database of retail items stored on, data storage device 106, for example, and identify one or more retail add-on items that are associated with the selected retail items. The server 102 may then communicate suggestions for add-ons to the consumer. In another embodiment, the server 102 may communicate an advertisement for an accessory item associated with one or more items selected by the customer. The advertisements or suggestions may be communicated to the customer by displaying them on one of the user interface devices 408-412.

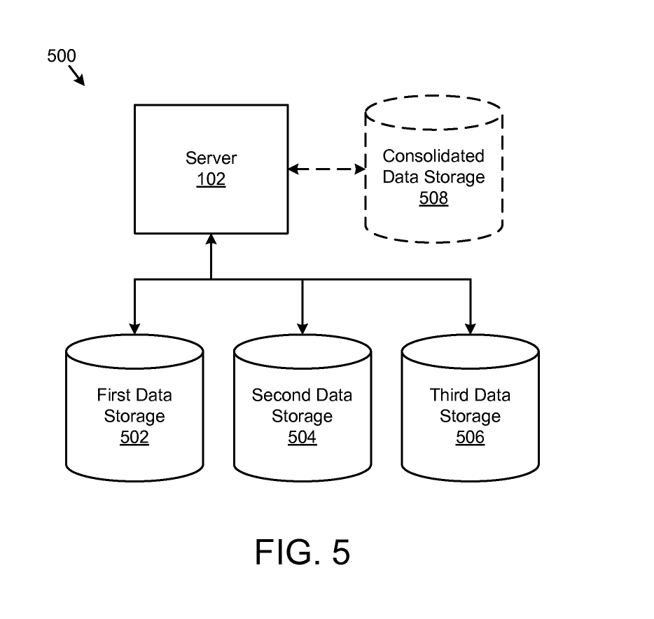

FIG. 5 illustrates one embodiment of a data management system 500 configured to store and manage data for retail add-on sales. In one embodiment, the system 500 may include a server 102. In one embodiment, the system 500 may also include a first data storage device 502, a second data storage device 504 and/or a third data storage device 506. In further embodiments, the system 500 may include additional data storage devices (not shown). In such an embodiment, each data storage device 502-506 may host a separate database of core retail items, accessory retail items, and/or associations between sets of core and accessory retail items. The customer information in each database may be keyed to a common field or identifier, such as a SKU number, a record identifier number, a package or kit identifier number, or the like. Alternatively, the storage devices 502-506 may be arranged in a RAID configuration for storing redundant copies of the database or databases through either synchronous or asynchronous redundancy updates.

In one embodiment, the server 102 may submit a query to selected data storage devices 502-506 to collect a consolidated set of data elements associated with a set of retail items. The server 102 may store the consolidated data set in a consolidated data storage device 508. In such an embodiment, the server 102 may refer back to the consolidated data storage device 508 to obtain a set of data elements associated with a specified individual. Alternatively, the server 102 may query each of the data storage devices 502-506 independently or in a distributed query to obtain the set of data elements associated with a specified individual. In another alternative embodiment, multiple databases may be stored on a single consolidated data storage device 508.

In various embodiments, the server 102 may communicate with the data storage devices 502-508 over a data-bus. The data-bus may comprise a SAN, a LAN, or the like. The communication infrastructure may include Ethernet, Fibre-Chanel Arbitrated Loop (FC-AL), Small Computer System Interface (SCSI), and/or other similar data communication schemes associated with data storage and communication. For example, there server 102 may communicate indirectly with the data storage devices 502-508; the server 102 first communicating with a storage server or storage controller 104.

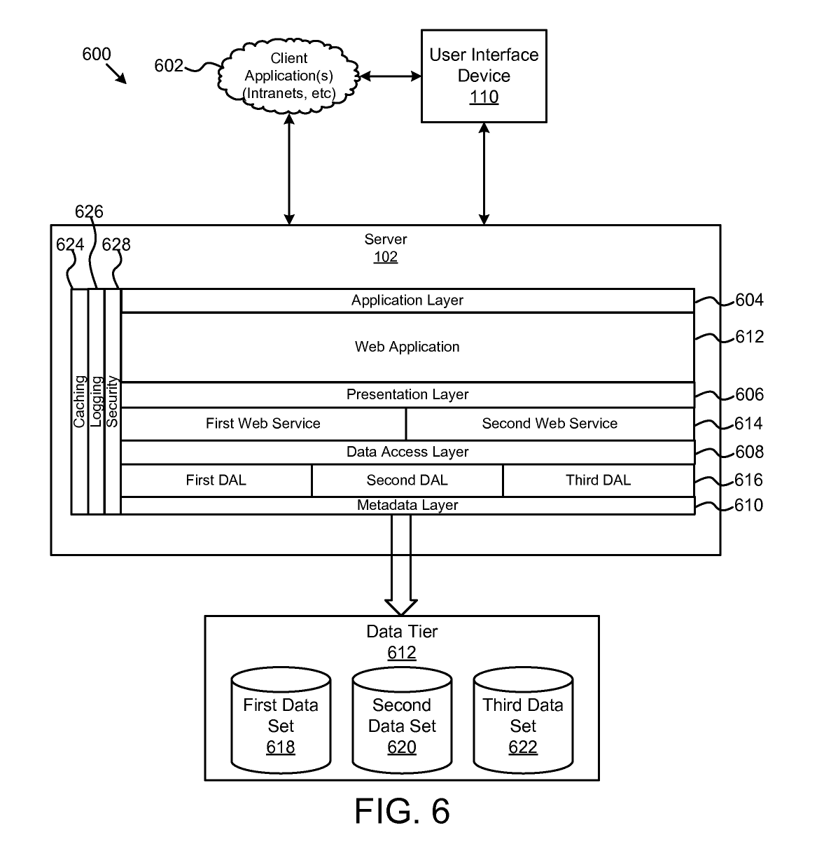

FIG. 6 illustrates one embodiment of a network-based system 600 for retail add-on sales. In one embodiment, the network-based system 600 includes a server 102. Additionally, the network-based system 600 may include a user interface device 110, such as a smartphone, tablet computing device, POS device, inventory control device, etc. In still a further embodiment, the network-based system 600 may include one or more network-based client applications 602, such as a mobile app, POS application, web service, or the like, configured to be operated over a network 108 including an intranet, the Internet, or the like. In still another embodiment, the network-based system 600 may include one or more data storage devices 104.

The network-based system 600 may include components or devices configured to operate in various network layers. For example, the server 102 may include functions configured to work within an application layer 604, a presentation layer 606, a data access layer 608 and a metadata layer 610. In a further embodiment, the server 102 may access one or more data sets 622-622 that comprise a data layer or data tier 612. For example, a first data set 622, a second data set 620 and a third data set 622 may comprise a data tier 612 that is stored on one or more data storage devices 502-508.

One or more web applications 612 may operate in the application layer 604. For example, a user may interact with the web application 612 for retail add-on sales that includes software functions configured to perform the steps of receiving an input comprising indicia of a retail item selection, searching a database of add-on items available for retail purchase, the database being organized according to a hub and spoke scheme, for one or more add-on items associated with the retail item selection, and generating an output associated with the one or more add-on items associated with the retail item selection in response to the search.

In a further embodiment, the server 102 may include components, devices, hardware components, or software units configured to operate in the presentation layer 606 to support one or more web services 614. For example, a web application 612 may access or provide access to a web service 614 to perform one or more web-based functions for the web application 612. In one embodiment, a web application 612 may operate on a first server 102 and access one or more web services 614 hosted on a second server (not shown) during operation.

For example, a web application 612 for receiving one or more indicia of selected items and displaying one or more suggestions or advertisements for add-on items, or other information may access a first web service 614 for receiving items selections and a second web service 614 for displaying advertisements associated with add-on items identified by the search. The web services 614 may receive indicia, such as on-line retail item selection. In response, the web service 614 may return data associated with the search results, such as suggestions or advertisements for retail add-ons. One of ordinary skill in the art will recognize various web-based architectures employing web services 614 for modular operation of a web application 612.

In one embodiment, a web application 612 or a web service 614 may access one or more of the data sets 618-622 through the data access layer 608. In certain embodiments, the data access layer 608 may be divided into one or more independent data access layers 616 for accessing individual data sets 618-622 in the data tier 612. These individual data access layers 616 may be referred to as data sockets or adapters. The data access layers 616 may utilize metadata from the metadata layer 610 to provide the web application 612 or the web service 614 with specific access to the data set 612.

For example, the data access layer 616 may include operations for performing a query of the data sets 618-622 to retrieve specific information for the web application 612 or the web service 614. In a more specific example, the data access layer 616 may include a query for a set of accessory items associated with the selected core retail item.

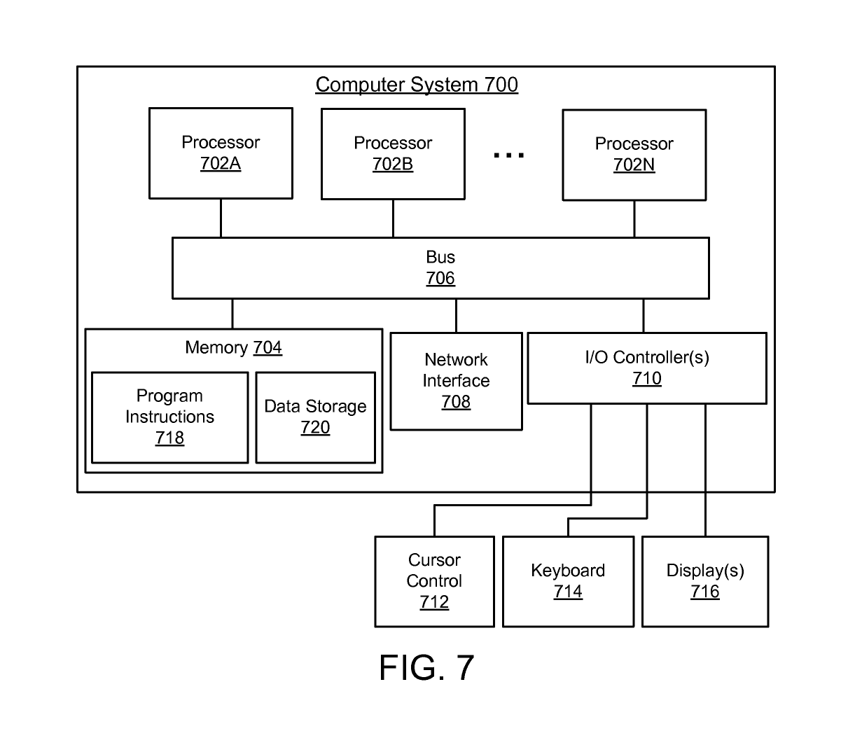

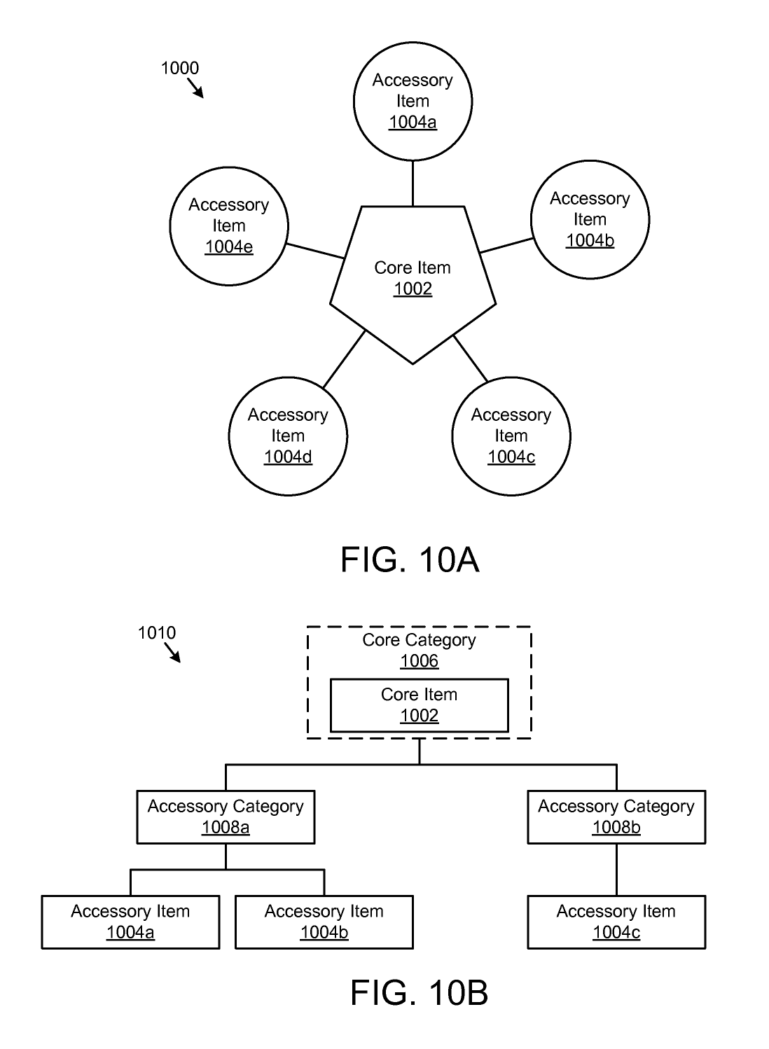

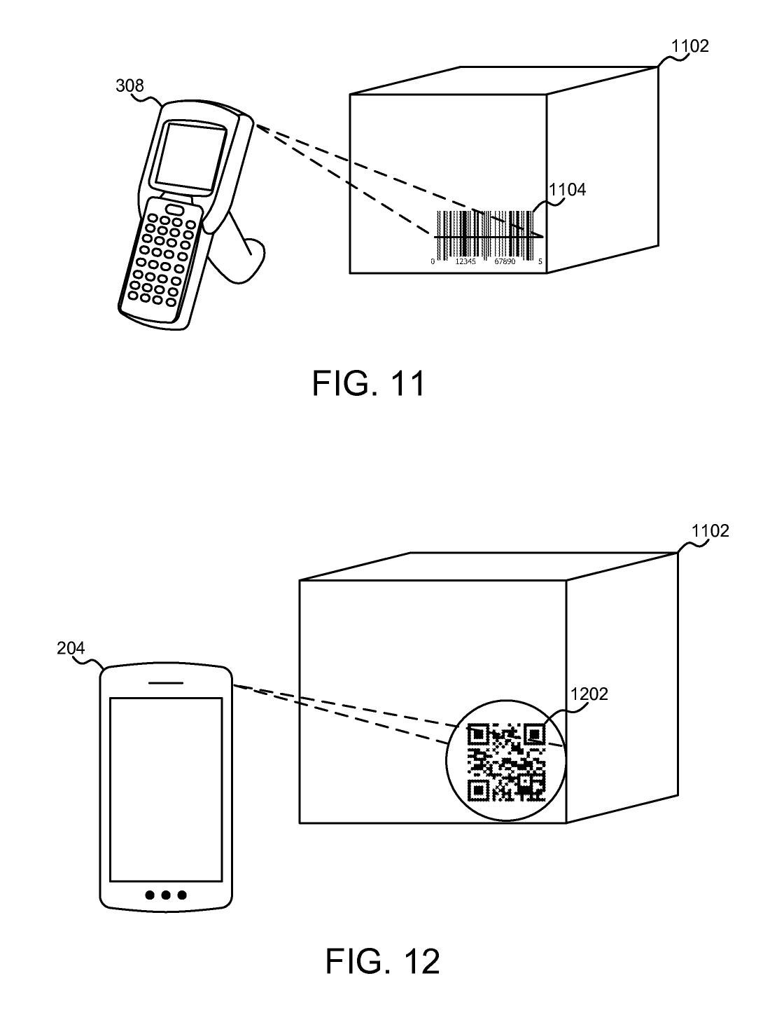

FIG. 7 illustrates a data processing system 700 adapted according to certain embodiments of the server 102 and/or the user interface device 110. The central processing unit (CPU) 702 is coupled to the system bus 704. The CPU 702 may be a general purpose CPU or microprocessor. The present embodiments are not restricted by the architecture of the CPU 702, so long as the CPU 702 supports the functions and operations as described herein. The CPU 702 may execute the various logical instructions according to the present embodiments. For example, the CPU 702 may execute machine-level instructions according to the exemplary operations described below with reference to FIGS. 10-11.

The data processing system 700 may also include Random Access Memory (RAM) 708, which may be SRAM, DRAM, SDRAM, or the like. The data processing system 700 may utilize RAM 708 to store the various data structures used by a software application configured to retail add-on sales. The data processing system 700 may also include Read Only Memory (ROM) 706 which may be PROM, EPROM, EEPROM, optical storage, or the like. The ROM may store configuration information for booting the data processing system 700. The RAM 708 and the ROM 706 hold user and system 100 data.

The data processing system 700 may also include an input/output (I/O) adapter 710, a communications adapter 714, a user interface adapter 716, and a display adapter 722. The I/O adapter 710 and/or user the interface adapter 716 may, in certain embodiments, enable a user to interact with the data processing system 700 in order to input indicia of a selected retail item. In a further embodiment, the display adapter 722 may display a graphical user interface associated with a software or web-based application for retail add-on sales.

The I/O adapter 710 may connect to one or more storage devices 712, such as one or more of a hard drive, a Compact Disk (CD) drive, a floppy disk drive, a tape drive, to the data processing system 700. The communications adapter 714 may be adapted to couple the data processing system 700 to the network 106, which may be one or more of a LAN and/or WAN, and/or the Internet. The user interface adapter 716 couples user input devices, such as a keyboard 720 and a pointing device 718, to the data processing system 700. The display adapter 722 may be driven by the CPU 702 to control the display on the display device 724.

The present embodiments are not limited to the architecture of data processing system 700. Rather the data processing system 700 is provided as an example of one type of data processing system that may be adapted to perform the functions of a server 102 and/or the user interface device 110. For example, any suitable processor-based device may be utilized including without limitation, including smartphones, tablet computing devices, a POS device, an inventory control device, and servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

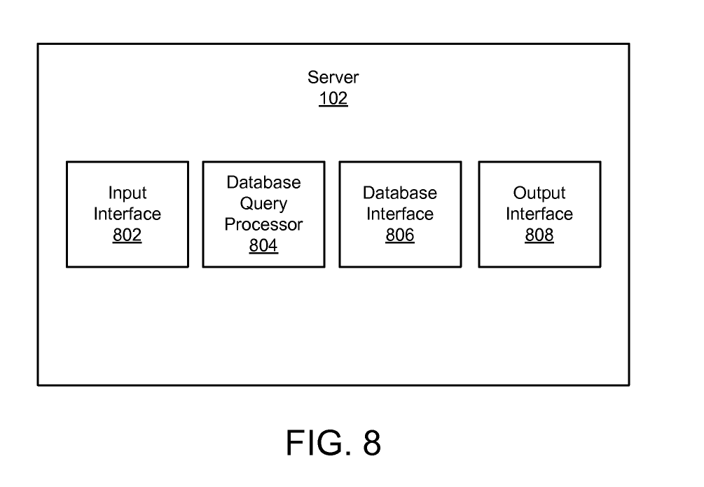

FIG. 8 illustrates one embodiment of a server 102. In an embodiment, the server 102 may include an input interface 802, a database query processor 804, a database interface 806, an output interface 808, etc. In an embodiment, the server 102 may receive an input, search a database of retail add-on items in response to the input, and provide an output to a user interface device 110 in response to the search results.

In an embodiment, the input interface 802 may include, for example, one or more I/O controllers 710. In another embodiment, the input interface 802 may be a network interface 708. The input interface 802 may receive an input from a user interface device 110. For example, the input interface 802 may receive an indicia of a retail item selection, such as a SKU number associated with a selection of a retail item.

In an embodiment, the database query processor 804 may generate a database query in response to the received indicia. The database query processor 804 may search the database of add-on items available for retail purchase, the database being organized according to a hub and spoke scheme, for one or more add-on items associated with the retail item selection. For example, the query processor 804 may request a set of accessory items associated with a selected core item. In another embodiment, the query processor 804 may request a core item associated with a selected accessory item, as well as a set of accessory items associated with the core item. In an embodiment, the database query processor 804 may generate an SQL query. In other embodiments, the database query processor 804 may create a .xml file containing query instructions, an access database query, or the like.

The database interface 806 may connect to the database for conducting operations, such as database searches, dataset definitions, data association definitions, etc. In an embodiment, the database interface 806 may communicate with the data storage device 106. In a further embodiment, the database interfaced 806 may communicate with the data storage controller 104.

The output interface 808 may communicate an output associated with the one or more add-on items associated with the retail item selection in response to the search results. In one embodiment, the output interface 808 may communicate a suggestion for the one or more add-on items to the user interface device 110. In another embodiment, the output interface 808 may communicate an advertisement associated with one or more identified add-on items. One of ordinary skill may recognize additional information associated with the one or more identified add-on items which may be communicated via the output interface 808. In an embodiment, the output interface may be a display device 716. In another embodiment, the output interface may be a network interface 708. One of ordinary skill will recognize other physical embodiments of an output interface 808.

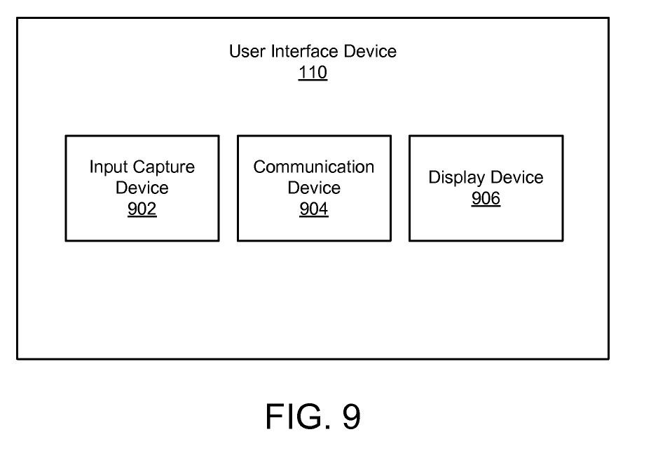

FIG. 9 illustrates one embodiment of a user interface device 110. In an embodiment, the user interface device 110 may include a smartphone device, a tablet computer device, a POS device, or the like. The user interface device 110 may include, in various emboidments, an input capture device 902 such as a touchscreen, a camera, a barcode reader, a QR code reader, or the like. The user interface device 110 may also include a communication device, such as a network interface card, a Bluetooth Personal Area Network (PAN) card, a WiFi interface card, or the like. The user interface device 110 may also include a display device 906. The display device 906 may be a touchscreen device, an external monitor, a Liquid Crystal Display (LCD) POS display panel, or the like.

FIG. 10A illustrates one embodiment of a hub and spoke scheme 1000. In an embodiment, the scheme 1000 is organized with a core item 1002 and one or more accessory items 1004a-e associated with the core item 1002. In further embodiments, multiple core items may be related to the accessory items 1004a-e. In still further embodiments, a single accessory item 1004a may be associated with multiple core items 1002, but a core/accessory relationship would still exist between each core item 1002 and the shared accessory item 1004a, in such an embodiment.

In a further embodiment, as described in FIG. 10B, a modified hub and spoke scheme 1010 may include core items 1002 and accessory items 1004a-e each arranged in categories. For example, a core item 1002 may be included in a core category 1006, and accessory items 1004a-c may be arranged in accessory categories 1008a-b respectively. For illustration purposes, in a holiday or party retail environment, a core category 1006 may be a “costume” category. The core item 1002 may be a particular costume item, such as a Dracula costume. In such an embodiment, the first accessory category 1008a may be makeup items. Accessory item 1004a may be white face paint, and accessory item 1004b may be red lipstick. The Accessory Category 1008a for makeup may be associated with core item 1002 for the Dracula costume, because customers often purchase makeup with Dracula costumes. White face paint and red lipstick may be specifically associated with Dracula costumes, because customers most often purchase these products together. A second accessory category 1008b may be costume enhancements, and included in the costume enhancements category 1008b may be an accessory item 1004c for a black cape.

FIG. 11 illustrates an embodiment of a system for entering information associated with a selected item. In the embodiment illustrated in FIG. 11, the selected item may be packaged in a package 1102 that includes a UPC barcode 1104. The UPC barcode 1104 may include information, such as a SKU number, that identifies the selected item. An inventory control device 308 may be used to scan the UPC barcode 1104, and communicate that information to the server 102. The server 102 may identify the one or more recommendations associated with the selected item according to the hub and spoke scheme 1000 or modified hub and spoke scheme 1010 as illustrated in FIGS. 10A-10B. The server 102 may then return the recommendation to the inventory control device 308 for display to an employee.

In the embodiment of FIG. 12, a customer may use a smartphone device 204 to scan, e.g., a QR code 1202 on the package 1102 of the selected item. In a first embodiment, the smartphone may communicate over customer access network 202 to the server 102, which may return the recommendations. In an alternative embodiment, the QR code may direct the smartphone to a web page for accessing the server 102 over an extended network 406, which may return the recommendation. In still a further embodiment, the smartphone 204 may communicate information encoded in the QR code directly to the server 102 over the extended network 406 using a pre-established connection.

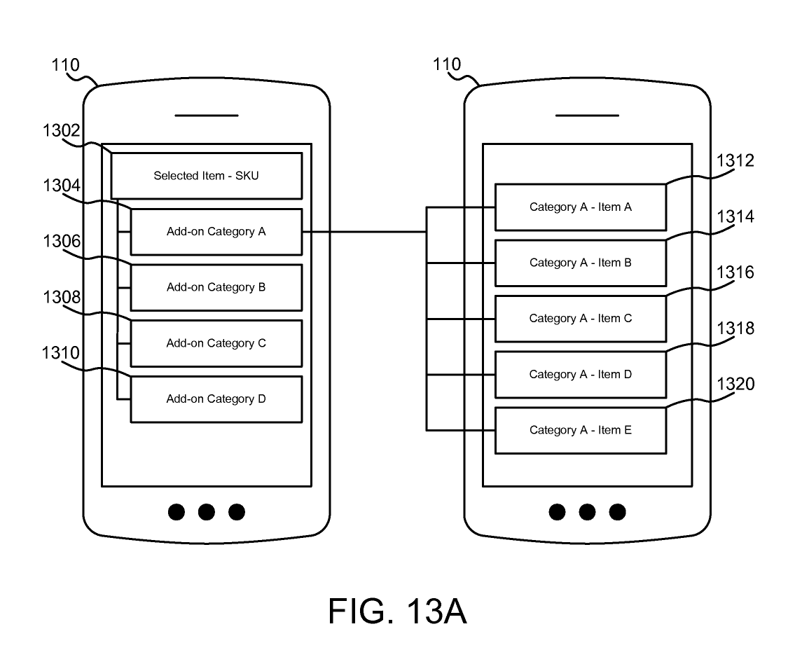

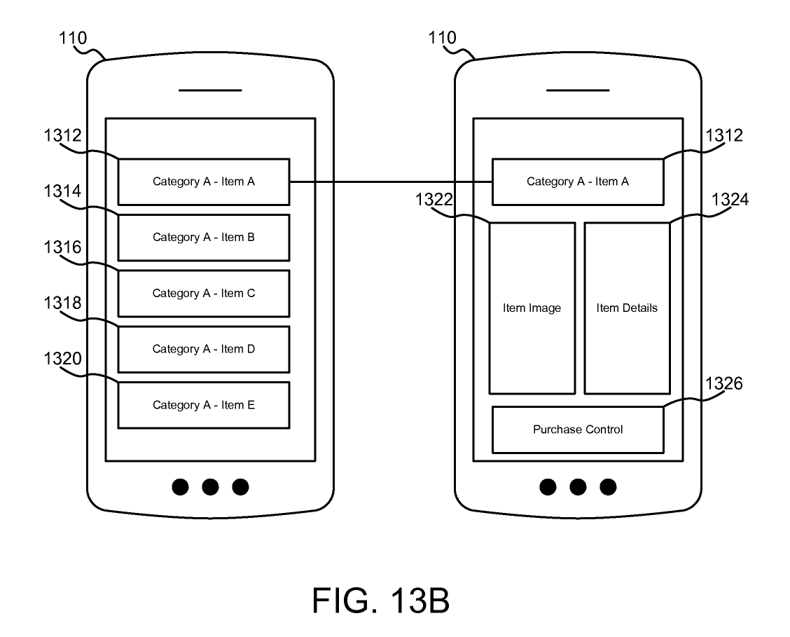

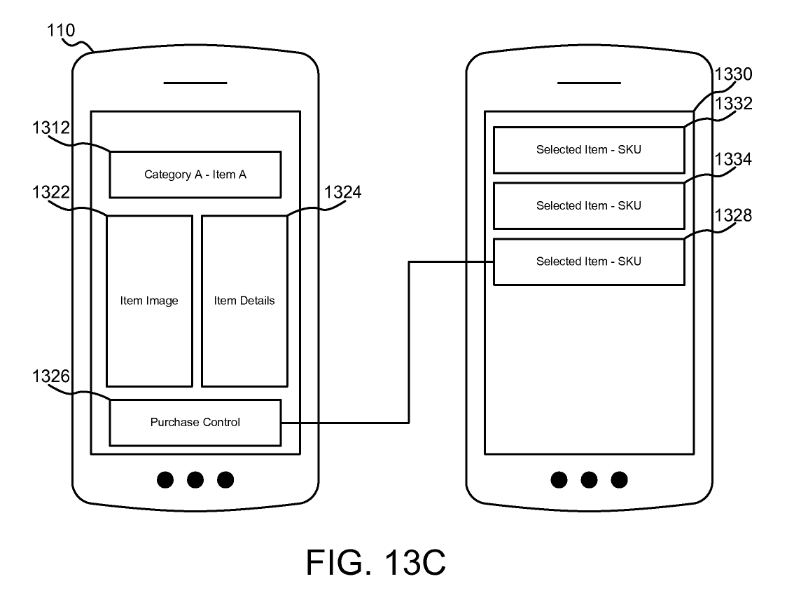

FIGS. 13A-C illustrate an embodiment of an application flow for retail add-on sales. In an embodiment, the application may operate on a user interface device 110, such as a smartphone device. In alternative embodiments, the application may operate on a mobile data device, a tablet computer, a laptop computer, a desktop computer, an inventory control device, a POS device, or the like. In an embodiment, the user interface device 110 may receive an indicator of a selected item 1302, such as a SKU. The user interface device 110 may communicate information about the selected item 1302 to the server 102 and receive a list of add-on categories according to the hub and spoke algorithm 1010, as illustrated in FIG. 10B. For example, the user interface device 110 may display an icon associated with add-on category A 1304, add-on category B 1306, add-on category C 1308, and add-on category D 1310.

Upon selection of Add-on category A 1304 by a user, the user interface device 110 may display items within add-on category A 1304, including item A 1312, item B 1314, item C 1316, item D 1318, and item E 1320. Upon selection of one of the items, for example item A 1312, as shown in FIG. 13B, further item details 1324 may be displayed. Item details 1324 may include the SKU associated with the item, the item price, an item description, item specifications, item reviews, etc. Additionally, an item image 1322 may be displayed. A purchase control 1326 may also be displayed. The purchase control 1326 may be an item selection button, or the like. As shown in FIG. 13C, the purchase control 1326 may place the item in the customer's list 1330 of items to be purchases, such as an online shopping cart, a POS purchase list, or the like. As illustrated, the purchase list 1330 may include identifiers of one or more selected items 1332-1334 as well as information, such as a SKU for the selected retail add-on 1328.

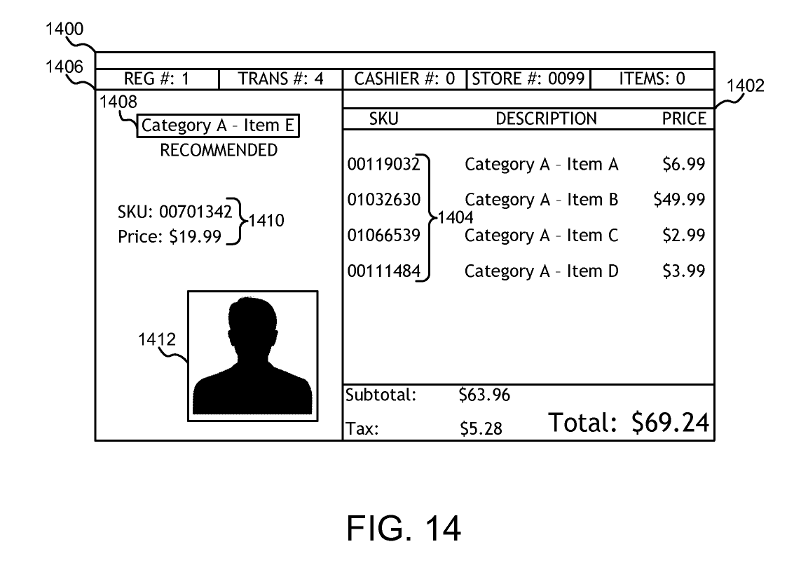

FIG. 14 illustrates an embodiment of a graphical interface 1400 for a POS display. In an embodiment, the graphical interface 1400 may include an order panel 1402 configured to list items selected for purchase on a customer's order. For example, selected items may be listed by item selection numbers 1404, such as SKUs. In an embodiment, a description and price for each selected item may also be displayed. In an embodiment, the graphical interface 1400 may also include a recommendations panel 1406. The recommendations panel 1406 may display a recommendation 1408 for a retail add-on item, such as for Category A—Item E as shown in the embodiment. In such an embodiment, the server 102 may determine that each of the items A-D in category A have been selected by the customer, and may recommend the remaining item in the group (item E). In further embodiments, the server 102 may provide recommendation data according to the hub and spoke schemes described in FIGS. 10A-10B. The recommendation panel 1406 may include information 1410 descriptive of the recommended item, such as the SKU and price. Additionally, the recommendation panel 1406 may include an image 1412 of the recommended item. In an embodiment, the customer may directly add the recommended item by selecting a selectable button associated with recommendation 1408. Alternatively, the retail employee may add the recommended item 1408 to the order via one or more user controls.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

What is claimed is:

1. A method comprising:
receiving an input at an input interface, the input comprising indicia of a retail item selection;
searching a database of add-on items available for retail purchase, the database being organized according to a hub and spoke scheme, for one or more add-on items associated with the retail item selection;
generating an output associated with the one or more add-on items associated with the retail item selection in response to the search.

2. The method of claim 1, further comprising defining a set of core items to be included in the hub and spoke scheme.

3. The method of claim 2, further comprising defining a set of accessory items to be associated with each core item in the set of core items.

4. The method of claim 3, further comprising defining associations between each core item in the set of core items and a corresponding set of accessory items.

5. The method of claim 1, wherein the output is an advertisement for the one or more items associated with the retail item selection.

6. The method of claim 1, wherein the output is a suggestion for adding the one or more items associated with the retail item selection to an order for purchase at a point-of-sale (POS) device.

7. The method of claim 1, wherein the output is a suggestion for adding the one or more items associated with the retail item selection to an on-line order.

8. A system comprising:
an input at an input interface configured to receive an input comprising indicia of a retail item selection;
a processing device in communication with the input interface, the processing device configured to search a database of add-on items available for retail purchase, the database being organized according to a hub and spoke scheme, for one or more add-on items associated with the retail item selection; and
an output interface in communication with the processing device, the output interface configured to generate an output associated with the one or more add-on items associated with the retail item selection in response to the search.

9. The system of claim 8, further comprising a user interface device in communication with the input interface and the output interface, the user interface device configured to capture the input and to display the output.

10. The system of claim 8, wherein the user interface device is a mobile data device.

11. The system of claim 8, wherein the user interface device is a point-of-sale device.

12. The system of claim 8, wherein the user interface device is an inventory control device.

13. The system of claim 8, wherein the input is a Stock Keeping Unit (SKU) number associated with the retail item selection.

14. The system of claim 8, wherein the input is derived from a Quick Response (QR) code comprising the indicia of the retail item selection.

15. A tangible machine-readable medium comprising machine-executable instructions that, when executed by a machine, cause the machine to perform operations comprising:
receiving an input at an input interface, the input comprising indicia of a retail item selection;
searching a database of add-on items available for retail purchase, the database being organized according to a hub and spoke scheme, for one or more add-on items associated with the retail item selection;
generating an output associated with the one or more add-on items associated with the retail item selection in response to the search.

16. The tangible machine-readable medium of claim 15, The method of claim 1, further comprising defining a set of core items to be included in the hub and spoke scheme.

17. The tangible machine-readable medium of claim 16, further comprising defining a set of accessory items to be associated with each core item in the set of core items.

18. The tangible machine-readable medium of claim 17, further comprising defining associations between each core item in the set of core items and a corresponding set of accessory items.

19. The tangible machine-readable medium of claim 15, wherein the output is an advertisement for the one or more items associated with the retail item selection.

20. The tangible machine-readable medium of claim 15, wherein the output is a suggestion for adding the one or more items associated with the retail item selection to an order for purchase at a point-of-sale (POS) device.

21. The tangible machine-readable medium of claim 15, wherein the output is a suggestion for adding the one or more items associated with the retail item selection to an on-line order.
